(19) United States
(12) Patent Application Publication
(10) Pub. No.: US 2025/0259571 A1
(43) Pub. Date: Aug. 14, 2025

(54) Information Device for Controlling a Display of Information

(71) Applicant: ABB Schweiz AG, Baden (CH)

(72) Inventor: Fabrice Martins, Saint Genis Laval (FR)

(73) Assignee: ABB Schweiz AG, Baden (CH)

(21) Appl. No.: 19/047,188

(22) Filed: Feb. 6, 2025

(30) Foreign Application Priority Data
Feb. 8, 2024 (EP) 24156605

(51) Int. Cl. G09F 9/33; G02F 1/01

(52) U.S. Cl. CPC G09F 9/33; G02F 1/0121

(57) ABSTRACT

An information device for controlling a display of information includes a LED film having a surface with a first area and a second area, a configurable LED panel, wherein the LED panel is part of the first area; and a control interface, wherein the control interface is part of the second area of the LED film and is configured to receive a control command from a control device to adapt the display of information on the first area of the LED panel of the information device.

### CROSS-REFERENCE TO RELATED APPLICATIONS

The instant application claims priority to European Patent Application No. 24156605.8, filed Feb. 8, 2024, which is incorporated herein in its entirety by reference.

### FIELD OF THE DISCLOSURE

The present disclosure generally relates to an information device for controlling a display of information.

### BACKGROUND OF THE INVENTION

Existing signage products in prior art use often a rigid and fixed pictogram that needs to be changed due to installation constraints, e.g. right, left, up, down etc., in terms of a position of said product that is no longer suitable.

The installation of such a signage product is mainly on a ceiling, a wall or recessed and such an installation is most often obtrusive.

Further, in case the layout of the signage product needs to be changed to due to adapt the product to another application scenario, installation and removal of the signage product needs to be performed by qualified personal which leadings to increasing operation costs of such a signage product.

### BRIEF SUMMARY OF THE INVENTION

Therefore, it would be advantageous to provide an improved concept for an information device that can be configured due to varying application scenarios in an efficient and cost-saving manner.

In a first aspect, the present disclosure describes an information device for controlling a display of information, comprising: a LED film having a surface with a first area and a second area, a configurable LED panel, wherein the LED panel is part of the first area; and a control interface, wherein the control interface is part of the second area of the LED film and is configured to receive a control command from a control device to adapt the display of information on the first area of the LED panel of the information device.

In other words, a core idea is to use a flexible and configurable LED film that includes a LED panel to display at least one information object such as text, pictures, e.g. in form of pictograms, in a static and/or dynamic manner. The information device is configurable and can be easily controlled to adapt the displayed object information when an application or use-case scenario changes. The LED film can be installed on any surface of an object and can be easily re-positioned without extensive knowledge of qualified staff.

The present information device has further advantages: Tool-less installation in an easy manner. There is no need to prepare a surface of an object for installation of the information device, e.g. wiring, drilling etc. Easy refurbishment. Transparent property, even if the picture displayed in enlightened.

### BRIEF DESCRIPTION OF THE SEVERAL VIEWS OF THE DRAWING(S)

FIG. 1 illustrates a schematic information device according to an embodiment of the present disclosure.

### DETAILED DESCRIPTION OF THE INVENTION

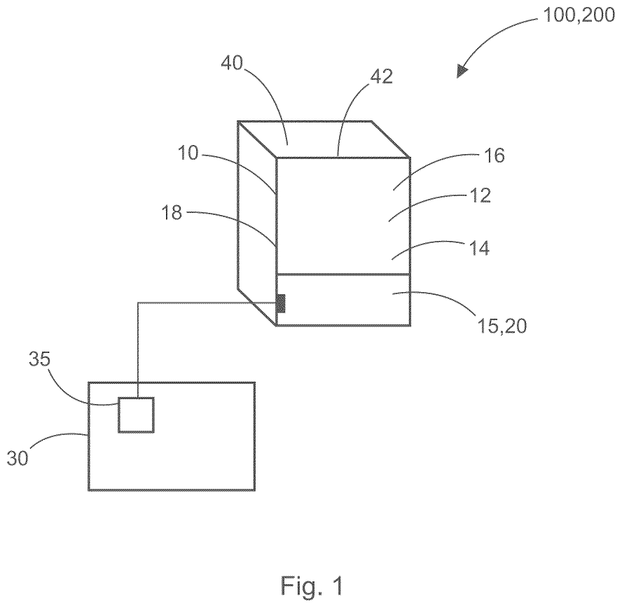

FIG. 1 illustrates a schematic information device 100 for controlling a display of information on said information device according to an embodiment of the present invention.

The information device 100 for controlling or configuring/adapting a display of information, comprises a LED film 10 having a surface 12 with at least one area 14 or with a first area 14 and a second area 15, as depicted in FIG. 1.

The LED film 10 may be a transparent LED film that is known in prior art and which can be used as a basis component to be adapted for the information device 100 of the present invention. Therefore, it is not necessary to provide further details of the LED film 10 herein.

The information device 100 further comprises a configurable LED panel component 16, wherein the LED panel 16 is part of the first area 14. However, the LED panel 16 may be arranged in any other position or area within the LED film 10.

Further, the LED panel 16 may be connected to a power supply that may be installed inside the information device 100 or externally of the information device 100.

The information device 100 further comprises a control interface 20. Preferably, the control interface 20 is part of the second area 15 of the LED film 10. However, the control interface 20 may also be positioned on any other suitable part of the information device 100 or the LED film 10, if the application scenario requires so.

The control interface 20 is configured to receive a control command 35 from a control device 30 to adapt the display of information on the first area 14 of the LED panel 16 of the information device 100.

Optionally, at least some part of the control device 30 is part of the information device 100 and connectable to the control interface 20 of the information device 100, e.g. by a wireless or wired connection. The control device 30 may, however, be embodied as an electronic device, e.g. a computer, a smartphone, a tablet, and the like, which is able to generate a corresponding control command 35 to control the information device 100 based on input provided by a user and/or an automated control system.

The information display 100 may be part of a display system 200. The display system 200 may comprise a computer that is connectable or connected to the information device 100 in a cable-mounted and/or wireless manner.

Optionally, the information device 100 comprises a fixing component 18 that can be applied to at least a part of the surface 12 of the LED film 10. In this way, the information device 100 can be applied on a second surface 42 of an object 40, e.g. a window, a door etc. The second surface 42 of the object 40 may be a flat surface or a surface of any dimension or shape. The fixing component 18 may be any suitable means to fast or fix the information device 100 onto the second surface of the object 40. The fixing component 18 may involve for example mechanical, adhesive, magnetic or any other suitable means.

Optionally, the at least first or that at least one area 14 of the LED film 10 has a transparent property that is configurable by the control device 30.

Optionally, a luminance value or a luminance property (value) of the LED film 10 is configurable between a security mode and maintained mode, wherein in the security mode the LED film 10 has a luminance value of at least 2 cd/m² and wherein in the maintained mode the LED film 10 has a luminance value of about 500 cd/m².

Optionally, a contrast property of the LED film 10 between a green reference color and a white reference color is configurable between an x-coordinate-value of about 5 and a y-coordinate-value of about 15 in a chromaticity diagram as defined by the ISO 3864-4 standard.

According to an example, the control device is part of the information device and connectable to the control interface of the information device. In this way, the information device can be controlled and handled in an efficient manner.

According to an example, the control interface is part of the LED film. In this way, the information device can be controlled and handled in an efficient manner.

According to an example, the information device comprises a fixing component applied to at least a part of the surface of the LED film to be able to apply the information device on a second surface of an object. In this manner, the information device can be installed in an efficient and cost-saving manner on any object component.

According to an example, at least the first area of the LED film has a transparent property that is configurable by the control device. In this way, a display property of the information device can be easily adapted to a changed application scenario.

According to an example, a luminance value of the LED film is configurable between a security mode and maintained mode, wherein in the security mode the LED film has a luminance value of at least 2 cd/m² and wherein in the maintained mode the LED film has a luminance value of about 500 cd/m². In this way, the information device can be flexibly operated in different operation modes suitable to a required application scenario.

According to an example, a contrast property of the LED film between a green reference color and a white reference color is configurable between a x-coordinate-value 5 and a y-coordinate-value 15 in a chromaticity diagram as defined in the ISO 3864-4 standard. In this manner, the information device can be flexibly adapted and operated in different operation modes suitable to a required application scenario.

In a second aspect of the present invention, a display system is provided comprising an information device according to any of the previous examples and/or according to the first aspect for configuring the information device.

In a third aspect of the present invention, a computer is provided comprising a processor configured to control the information device according to the first aspect and/or according to any of the previous examples.

In a fourth aspect of the present invention, a computer program product is provided comprising instructions which, when the computer program is executed by a processor of a computer, causes the computer to control the information device of the first aspect.

In a fifth aspect, a machine-readable data medium and/or download product is provided containing the computer program according to the third aspect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE SIGNS

10 LED film
12 Surface
14 First area
15 Second area
16 LED panel
18 Fixing component
20 Control interface
30 Control device
35 Control command
40 Object
42 Second surface
100 Information display
200 Display system

What is claimed is:

1. An information device for controlling a display of information, comprising:
a LED film having a surface with a first area and a second area;
a LED panel, wherein the LED panel is configurable and a part of the first area;
a control interface, wherein the control interface is part of the second area of the LED film and is configured to receive a control command from a control device to adapt the display of information on the first area of the LED panel of the information device.

2. The information device according to claim 1, wherein the control device is part of the information device and connectable to the control interface of the information device.

3. The information device according to claim 1, wherein the control interface is part of the LED film.

4. The information device according to claim 1, further comprising a fixing component applied to at least a part of the surface of the LED film, the fixing component being configured to apply the information device on a second surface of an object.

5. The information device according to claim 1, wherein at least the first area of the LED film has a transparent property that is configurable by the control device.

6. The information device according to claim 1, wherein a luminance value of the LED film is configurable between a security mode and maintained mode, wherein in the security mode the LED film has a luminance value of at least 2 cd/m² and wherein in the maintained mode the LED film has a luminance value of about 500 cd/m².

7. The information device according to claim 1, wherein a contrast property of the LED film between a green reference color and a white reference color is configurable between an x-coordinate-value and a y-coordinate-value in a chromaticity diagram as defined in the ISO 3864-4 standard.

8. A display system comprising an information device, the information device comprising:
a LED film having a surface with a first area and a second area;
a LED panel, wherein the LED panel is configurable and a part of the first area;
a control interface, wherein the control interface is part of the second area of the LED film and is configured to receive a control command from a control device to adapt the display of information on the first area of the LED panel of the information device.

9. The display system according to claim 8, wherein the control device is part of the information device and connectable to the control interface of the information device.

10. The display system according to claim 8, wherein the control interface is part of the LED film.

11. The display system according to claim 8, further comprising a fixing component applied to at least a part of the surface of the LED film, the fixing component being configured to apply the information device on a second surface of an object.

12. The display system according to claim 8, wherein at least the first area of the LED film has a transparent property that is configurable by the control device.

13. The display system according to claim 8, wherein a luminance value of the LED film is configurable between a security mode and maintained mode, wherein in the security mode the LED film has a luminance value of at least 2 cd/m² and wherein in the maintained mode the LED film has a luminance value of about 500 cd/m².

14. The display system according to claim 8, wherein a contrast property of the LED film between a green reference color and a white reference color is configurable between an x-coordinate-value and a y-coordinate-value in a chromaticity diagram as defined in the ISO 3864-4 standard.
